(19) United States
(12) Patent Application Publication
(10) Pub. No.: US 2015/0161602 A1
(43) Pub. Date: Jun. 11, 2015

(54) METHOD AND SYSTEM FOR SPLIT-HASHED PAYMENT ACCOUNT PROCESSING

(71) Applicant: MasterCard International Incorporated, Purchase, NY (US)

(72) Inventor: Christopher A. Guiney, Fenton, MO (US)

(73) Assignee: MasterCard International Incorporated, Purchase, NY (US)

(21) Appl. No.: 14/099,406

(22) Filed: Dec. 6, 2013

(51) Int. Cl. G06Q 20/38; G06Q 20/40

(52) U.S. Cl. CPC G06Q 20/385; G06Q 20/40

(57) ABSTRACT

Methods and systems for receiving an authorization request associated with a transaction, the authorization request including an account code; receiving a user code to associate with the account code; associating the account code and the user code together to form a payment account code; determining an account identifier corresponding to the payment account code; determining whether to map the payment account code to a primary account number (PAN); mapping, in response to the determination that the payment account code is to be mapped to the PAN, the payment account code to the PAN to ascertain a PAN corresponding to the payment account code; and sending the authorization request including the PAN to be authorized.

### BACKGROUND

Traditionally, a major concern of merchants, cardholders, and issuers of credit, debit, charge, and other types of cards and payment devices that include a representation of a primary account number (PAN) on or in the payment device is the safeguarding and prevention of fraud using the PAN. Typically, the PAN is printed and/or embossed on a surface and/or encoded on a magnetic stripe of the payment device. In some payment devices including an electronic element such as, for example, a contactless payment credit card having an integrated circuit and a memory component (i.e., a chip card) and an electronic wallet application for a mobile device, the PAN may be stored in an electronic format. A great number and variety fraud prevention measures and schemes have been proposed and/or implemented in an effort to prevent the fraudulent use of the PAN representations provided with conventional payment devices.

Some previous fraud prevention measures and techniques to combat a fraudulent use of PANs include, for example, a requirement for a piece of information in addition to the PAN in the processing of transactions involving the PAN. Some payment processing techniques require a card security code in addition to or “on top of” the PAN printed on or encoded on a credit card and a debit card transaction may require a user enter a personal identification number (PIN) in addition to the PAN printed on or encoded on a debit card. In the instance the card security code is printed on, stored in, or generated by the payment device (e.g., by a chip card), gaining possession of the payment device or the information on and/or in the payment device also results in obtaining the PAN and the additional information supposed to combat fraud.

Additionally, the fact that core account numbers are still the key identifier for PAN activities and PANs may be transmitted and stored by various entities in distributed online processing systems, PANs may be at risk of being retrieved by unscrupulous entities that may buy, sell, leverage, use, and otherwise compromise payment processing system associated with the distributed systems. As a consequence of the above-mentioned issues and others, the costs for account issuers related to fraud management, charge-backs, and the re-issuance of new cards continues to increase.

Therefore, it would be desirable to provide improved methods and systems for efficiently facilitating and processing payment card transactions where the relevancy of a PAN is reduced in a distributed payment transaction processing system.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, wherein:

FIG. 1 is a schematic diagram illustrating various aspects of the present disclosure, according to some embodiments herein;

FIG. 2 is a flow diagram of a process, according to some embodiments herein;

FIG. 3 is a block diagram of a distributed system for processing payment transactions, in accordance with some embodiments herein;

FIG. 4 is a flow diagram of a process that illustrates the entities associated with the operations therein, in accordance with some embodiments herein; and

FIG. 5 is a schematic block diagram of an apparatus, according to some embodiments herein.

### DETAILED DESCRIPTION

In general, and for the purpose of introducing concepts of embodiments of the present disclosure, a payment asset refers to, in general, a payment device of any embodiment (e.g., card, mobile telephone, a key fob, etc.) that may include a representation of a payment card number that is printed on, stored in, or encoded in a credit card, debit card, stored value card, gift card, and other payment cards. As used herein, the payment card number is referred to as the primary account number (PAN). Whereas traditional payment devices may include a PAN embossed on, printed on, or stored thereon, the various embodiments of the present disclosure do not have the PAN either printed on, embossed on, or stored in the payment asset(s) that may be issued to a cardholder user.

As used herein, the user or customer to whom a subject payment device is issued is referred to herein as a “cardholder” even though the payment device may be embodied in a configuration other than a card.

In accordance with some embodiments herein, a 2-factor authentication process is provided for a payment device issued by, for example, a financial institution and related to a payment account managed by the issuer. In some aspects, an embodiment of a method and system herein may include issuing a payment card asset or device having a first portion of a payment account code (PAC) printed or stored thereon. The first portion of the PAC may be stored on or in the payment device if the payment device has the capability to store the PAC in an encoded format in, for example, a memory chip, magnetic stripe, etc. The PAC may be associated with a PAN that identifies a certain payment account. While the PAC may be associated with a PAN, the PAC is not same as or a truncated version or an altered version of the PAN for a particular source of funds payment account. Neither the PAN, a truncated version, nor an altered version of the PAN is included on or in the issued payment device of the various embodiments herein. As used herein, the first portion of the PAC is referred to as an account code (AcctCode).

The AcctCode may be created by an issuer for a user cardholder. The AcctCode may be generated based on an algorithm which, in some embodiments, is related to the Bank Identification Number (BIN) and/or other parameters and fields of a PAN.

A second portion of the PAC may be generated and assigned to the user cardholder. This second portion of the PAC is not included on or in the payment device and is not typically distributed to the user with a delivery of the payment device. As used herein, this second portion of the PAC is referred to as a user code (UserCode). The UserCode may be assigned, by a payment network operator to a user for associating with the AcctCode issued by the issuer for a particular payment account. The UserCode may be communicated only to the user cardholder from the payment network operator. In this manner, the UserCode may only be known to the payment network operator and the user cardholder. The UserCode may typically be known (i.e., memorized) by the user.

Together, the AcctCode and the UserCode comprise the PAC. The PAC may be formed by associating the AcctCode and the UserCode with each other. In some embodiments, the AcctCode may comprise 12 numeric digits, the UserCode may comprise 4 numeric digits, and the AcctCode and UserCode may be concatenated to form a 16 digit numeric string PAC. The PAC may be 16 numeric digits in length, similar to a number of existing PAN numbering schemes. However, the PAC and the PAN associated with a particular payment account are distinct from each other and the value of the PAC is not the same as the value of the PAN.

In some aspects, the PAC may be 16 numeric digits in length similar to some PANs. In this regard, some aspects of the present disclosure may be more easily and efficiently accommodated by at least some existing legacy systems and devices involved in the processing of payment transactions, including but not limited to merchant POS (point of sale) systems, acquirer systems and payment network systems. Reflective of a total length of the PAC, in some embodiments the AcctCode may be 10 numeric digits long and the UserCode may be 6 numeric digits long so that the PAC (e.g., AcctCode+UserCode) is 16 numeric digits long. In some aspects, the PAC may comprise a 16 digit (or other length of) numeric digits formed by the AcctCode having a first set of numeric digits and the UserCode including a second set of numeric digits. In one embodiment, the AcctCode may be longer than the UserCode since a user may be responsible for knowing (i.e., remembering) the UserCode. Yet, in another embodiment the UserCode may be longer than the AcctCode.

Referring to the 2-factor authentication aspect of a payment device herein introduced above, the AcctCode printed on, stored on, or generated by the payment device may constitute a “possession” factor since it will be normally carried by the user cardholder and the UserCode may constitute a “knowledge” factor since it will normally be known by the user.

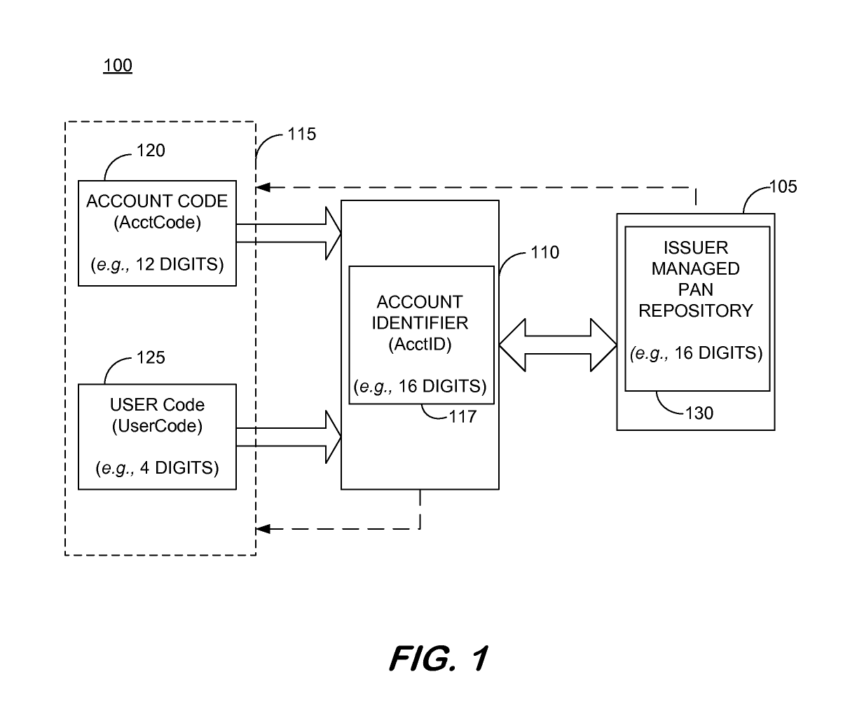

FIG. 1 is a schematic diagram illustrating various aspects of a system 100 that may support and facilitate a number of aspects of the present disclosure, according to some embodiments herein. System 100 includes an issuer 105, a payment network operator 110, and a user cardholder 115.

Issuer 105 may generate a PAN for a payment account managed and maintained by the issuer. Issuer 105 may further generate an AcctCode 120 for the payment account and issue a payment device to user cardholder 115, as illustrated via line 135. AcctCode 120 may comprise 12 numeric digits in some embodiments. The payment device issued to user cardholder 115 may have the AcctCode 120 printed and/or stored thereon, to the exclusion of the PAN. A record of the PAN associated with the AcctCode 120 may be maintained in a PAN repository 130 that may be managed by issuer 105. Issuer 105 may forward a record, message, or other indication of AcctCode 120 used on the issued payment device to payment network provider 110. Based on AcctCode 120 used on the issued payment device, payment network provider 110 may generate and assign an account identifier (AcctID) 117 to associate with AcctCode 120. In some aspects, payment network provider 110 may store a record or indication of the association relating to an AcctCode 120 and a corresponding AcctID 117. The record may include, in some aspects, a lookup table, a mapping, a database entry, and other data structures to maintain an record of the association between an AcctCode and its corresponding AcctID.

Payment network operator 110 may generate a UserCode 125 for the payment account that will be used to comprise the PAC and assigns the UserCode to cardholder 115. UserCode 125 may comprise 4 numeric digits in some embodiments. In some embodiments, payment network operator 110 may communicate UserCode 125 to cardholder 115. In some aspects, UserCode 125 is not communicated to cardholder 115 at the same time and in the same manner used to deliver AcctCode 120 to the cardholder. There may be a separation of at least one of the time and the communication channel used to deliver AcctCode 120 and UserCode 125 to user cardholder 115.

As an example of an illustrative use-case, a user may swipe a contact payment device or “tap” a contactless payment device in their possession at a merchant's POS terminal in order to use the payment device in conjunction with a payment transaction. Since the payment device of the present disclosure includes AcctCode 120 (not a PAN), AcctCode 120 may be forwarded to payment network operator 110 in a message such as an authorization request message for the present payment transaction. In further conjunction with the payment transaction, cardholder 115 may provide UserCode 125 known by them to payment network operator 110. In some aspects, UserCode 125 may be submitted via a manual keypad, a touch screen, an input to a voice recognition system, and other user interface input mechanisms to the merchant's POS terminal for forwarding to payment network operator 110.

In some embodiments, AcctCode 120 and UserCode125 may be forwarded to payment network operator 110 in a common or same message such as, for example, an authorization request message that may include additional details related to the payment transaction. In one embodiment, AcctCode 120 and UserCode125 may be forwarded to payment network operator 110 in separate messages.

Payment network operator 115 receives, obtains, or determines the PAC comprising AcctCode 120 and UserCode 125. In some embodiments, an entity such as an acquirer or an acquirer servicer (not shown in FIG. 1) may operate to facilitate, at least, associating the AcctCode 120 and UserCode 125 to form the PAC. In some aspects, the UserCode (e.g., 4 numeric digits) is concatenated to the end of the numeric string comprising the AcctCode (e.g., 12 numeric digits) to form the PAC (e.g., 16 numeric digits).

In some embodiments, payment network operator 110 may determine the particular AccctID 117 associated with the received PAC. In some aspects, the AccctID associated with the received PAC may be determined, at least in part, based on a record or mapping of an association of AcctID 117 with the AcctCode 120 comprising the received PAC.

In some embodiments, the actual PAN generated and issued by issuer 120 is managed and maintained in PAN repository 130. PAN repository 130 may include one or more data storage facilities, including for example a database management system and one or more memory systems. In some aspects, the PAN is not distributed to or stored by an entity other than issuer 105 such as a merchant, an acquirer, or payment network operator 115 since the PAN itself is not deployed with the payment device or used in the payment transaction processing before the authorization request message in the sent to issuer 105.

In some embodiments, the actual PAN generated and issued by issuer 120 is managed by the issuer and maintained in PAN repository 130, wherein the issuer may manage distribution of the PAN to a payment network operator. Issuer 105 may distribute the PAN to payment network operator 110 so that payment network operator 110 may map the received PAC to the PAN. In some aspects, payment network operator 110 may determine the mapping or association between the PAC and the PAN, at least in part, based on a record or mapping of an association of AcctID 117 with the AcctCode 120 comprising the received PAC. The PAN determined by payment network operator 110 may be passed or sent to issuer 105 in an authorization request message for authorization.

In some aspects, once the PAN is sent to or determined by issuer 105, all processing of the authorization request message, as well as clearing, settlement (e.g., charge-backs, etc.), card management, and licensing may be performed with the actual PAN.

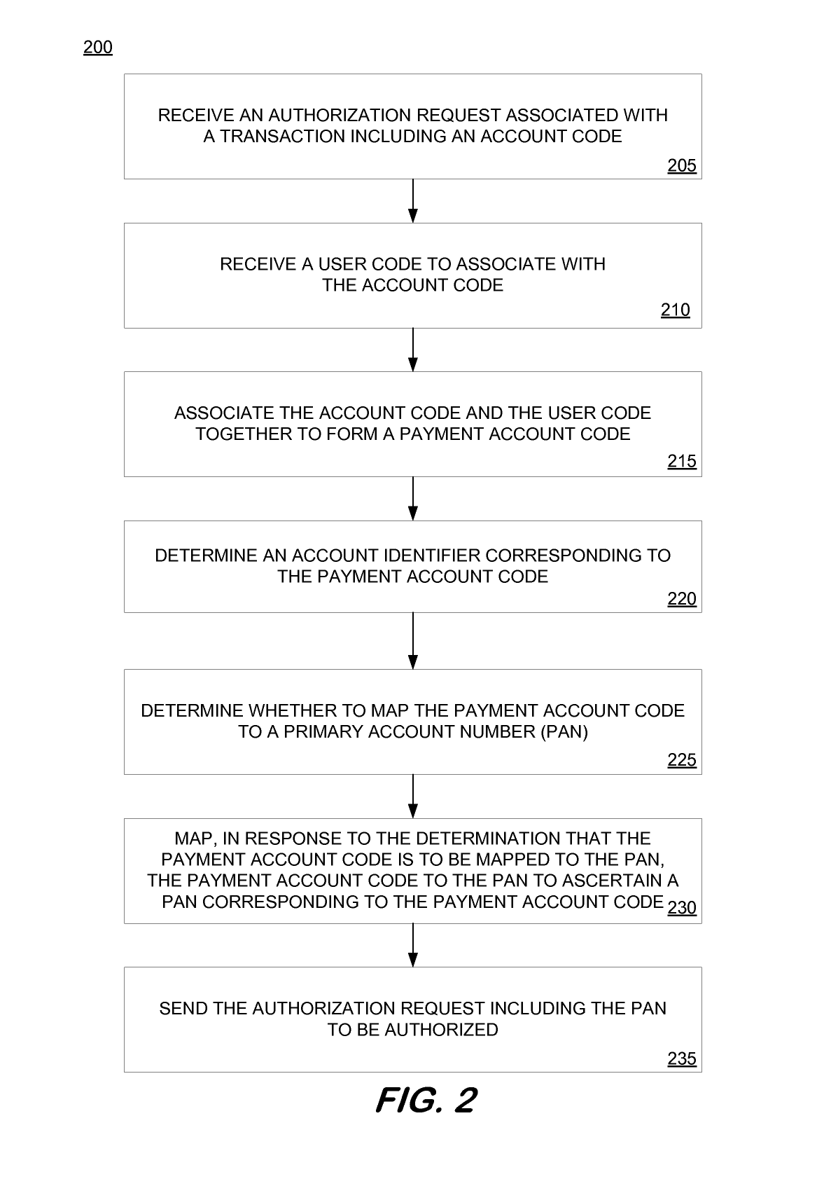

FIG. 2 is a flow diagram of a process 200, according to some embodiments herein. In particular, process 200 may reflect a method to process a payment transaction or purchase transaction (i.e., a transaction) by a payment network operator, service, server, or servicer according to some aspects herein. At operation 205, an authorization request associated with a transaction is received. The authorization may be received from an acquirer or acquirer agent related to a merchant participating in the transaction. In a departure from conventional transactions, the authorization request may not include a PAN issued by an issuer and corresponding to a payment account. Instead, the authorization request of operation 205 may include an account code, AcctCode, issued by the issuer, where the AcctCode is separate and distinct from the PAN and has a value that is not the same as the PAN's value. The issuer may issue the PAN however the PAN is not distributed on a payment device or stored by other entities in accordance with some aspects herein.

At operation 210, a user code, UserCode, is received from a user. The UserCode is to be associated with the AcctCode, where the AcctCode and the UserCode together form a payment account code, PAC, that will be used in the process of the transaction and act as representative identifier for the payment account maintained by the issuer. In some aspects, the UserCode may be supplied by the user cardholder participating in the transaction. It is noted that the UserCode may be need to form the PAC, as opposed to being a value supplied in addition to the PAC. In some instances, the UserCode and the AcctCode may both be received in the authorization request or some other same message, In some regards, the UserCode may be received in a message separate from the AcctCode.

At operation 215, the AcctCode and the UserCode are associated together to form the PAC. The associating of operation 215 may include concatenating the UserCode to a trailing (or leading) edge of the AcctCode. Other embodiments of operation 215 may involve other methods of obtaining or determining the PAC based on the AcctCode and UserCode, including, for example, substituting at least the received AcctCode with at least a portion of the UserCode, transforming the AcctCode and UserCode based on a predefined relationship or algorithm, and other techniques.

At operation 220, an account identifier, AcctID, corresponding to the PAC is determined. The AcctID may be a specific, non-PAN identifier generated by the payment network operator that is associated with the issued payment device that includes the AcctCode. In some embodiments, a record or other indication of the AcctCodes and corresponding AcctIDs mapped thereto may be maintained by the payment network operator.

Continuing to operation 225 of process 200, a determination may be made to determine whether the payment network operator is to map the PAC to the PAN. The determining of operation 225 may be based on, at least in part, on whether the payment network operator manages the PAN for the issuer of the PAN or whether the issuer (or an agent thereof) manages the PAN.

In an instance it is determined at operation 225 that the payment network operator manages the PAN for the issuer of the PAN and as a consequence the payment network operator is to map the PAC to the PAN, then the PAC is mapped to the PAN at operation 230. The PAN corresponding to the PAC is thereby obtained. The PAN may then be sent to be authorized in an authorization request, as indicated at operation 235. The PAN may be used in the further processing of the transaction, including, for example, clearing, settlement, and other payment device (e.g., card) management functions.

In some instances, it may be determined at operation 225 that the payment network operator does not manage the PAN or have access to the PAN. Accordingly, the payment network operator may map the PAC to the AcctID and subsequently send the AcctID corresponding to the PAC (and thus the AcctCode used in the present transaction) to the issuer who may then map the AcctID to the PAC. The issuer may be informed of the AcctID corresponding to the AcctCode by the payment network operator when the payment network operator generated the AcctID and assigned it to the AcctCode. The issuer may use the PAN in the further processing of the transaction, including, for example, clearing, settlement, and other payment device (e.g., card) management functions.

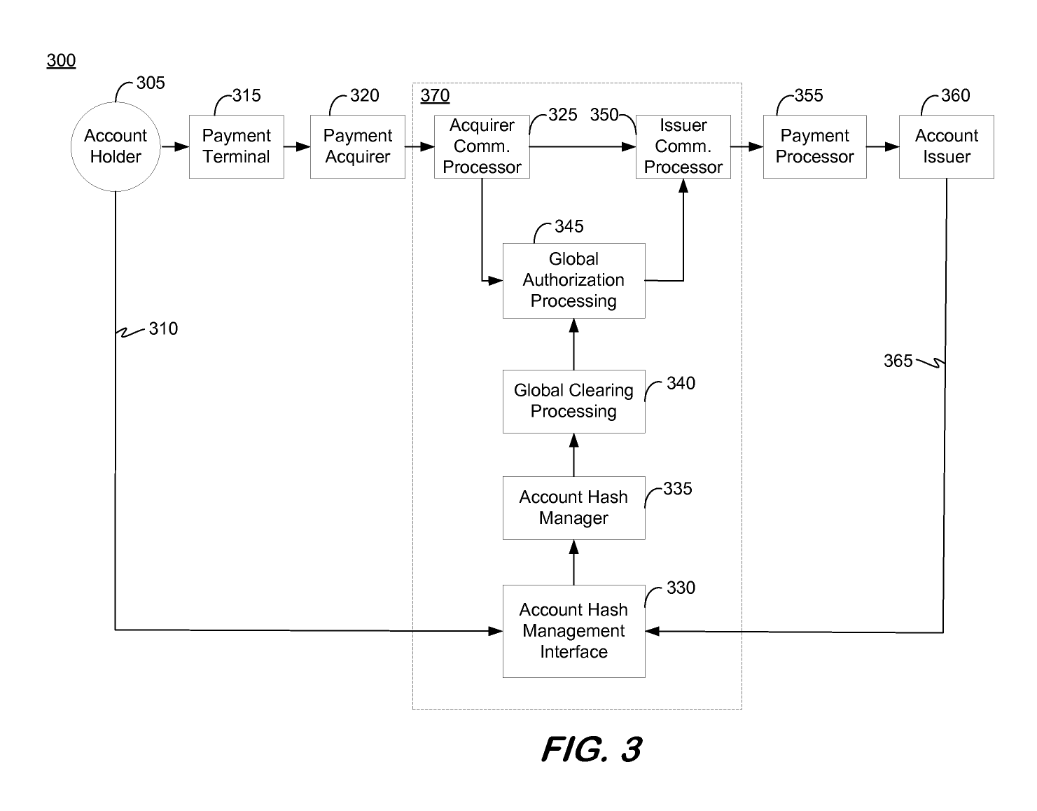

FIG. 3 is an illustrative block diagram of a system 300 that may support and facilitate aspects of the processes disclosed herein. In some regards, system 300 discloses a number of entities that may be involved in processing a transaction that relies on a payment device having an account code thereon and/or in (not a PAN) and a user cardholder having knowledge of a user code. In some aspects, system 300 may support online, ecommerce or card-not-present (CNP)transactions where the payment device (e.g., card) is not physically present with the user cardholder at the merchant at the time the transaction is commenced.

Referring to FIG. 3, user cardholder 305 may be issued a payment device (e.g., a credit card, a personalized electronic wallet application for execution by a mobile computing device, etc.) having an account code, AcctCode, printed on or encoded in or thereon. While the issuer issues the payment device with a corresponding PAN, the PAN is not distributed to or deployed with the payment device provided to user cardholder 305. In some aspects, user cardholder 305 may selectively and optionally register with payment network 370 in order to participate in a methodology disclosed herein including an issued payment device having an AcctCode (not a PAN).

Additionally, user cardholder 305 may obtain a user code, UserCode, from an operator of payment network 370, where the payment network operator generates and assigns the UserCode to user cardholder 305. Payment network 370 may receive requests for a UserCode via an account hash management interface 335 that provides access to the payment network. Account hash manager 340 may determine and map the UserCode to its associated AcctCode.

Account hash manager 340 may also generate and assign an AcctID to the AcctCode and provide other hashing or mapping functions in some aspects herein. For example, account hash manager 340 may operate to provide a mapping of a PAC (e.g., AcctCode+UserCode) to an AcctID and, in an instance payment network 370 will manage a PAN for the issuer, provide a mapping of the PAC (e.g., AcctCode+UserCode) to the appropriate corresponding PAN.

Regarding a CNP transaction for example, user cardholder 305 may selectively and optionally pre-authorize one or more e-commerce merchants with payment network 370. This pre-authorization process may include user cardholder 305 authorizing the payment network operator to process CNP transactions from specific, designated merchants in the future when payment network 370 receives requests to process CNP transactions involving the designated merchants. In some aspects, user cardholder 305 may pre-authorize payment network 370 to provide the cardholder's UserCode associated with their AcctCode if payment network 370 receives a request to process CNP transactions involving the designated pre-authorized merchant(s) and the user cardholder's AcctCode.

To commence a CNP transaction, user cardholder 305 may submit the AcctCode (e.g., 12 numeric digits) printed on their credit card (or displayed in a chip card's display, presented in a user interface screen of an electronic wallet app, etc.) and issued by account issuer 360 to a merchant's online payment terminal 315. In this example, the merchant is one of the designated pre-authorized merchants for the user cardholder. In some embodiments, the AcctCode may be deployed via an electronic wallet application executing on an electronic device belonging to and in the possession of the user cardholder. Payment terminal 315 may generate an authorization request and forward the authorization request to payment acquirer 320 that processes the transaction on behalf of the merchant involved in the transaction. Payment acquirer 320 may forward the authorization request including, at least, an identifier of the merchant and the AcctCode to payment network 370 via an acquirer communication processor 325 that interfaces with and provides access to payment network 370.

Upon receiving the authorization request, payment network 370 may determine whether the authorization request involves an AcctCode (not PAN). This determination may be based, at least in part, on the value of the AcctCode received in the authorization request. Payment network 370 may also determine whether the authorization request involves a pre-authorized merchant regarding the cardholder 305, where this determination may be based, at least in part, on the value of a merchant identifier received in the authorization request. In the instance it is determined that the current transaction does involve an AcctCode and a pre-authorized merchant regarding the cardholder 305, then payment network 370 may operate to associate the user cardholder's UserCode with the AcctCode to effectuate the formation of the PAC (e.g., AcctCode+UserCode). As noted above, the payment network operator may map the PAC to the corresponding AcctID and, in an instance payment network 370 will manage a PAN for the issuer, the payment network operator may provide a mapping of the PAC to the appropriate corresponding PAN.

Payment network 370 may, via global authorization processing module 345, provide an authorization message including the determined AcctID (in the instance issuer 360 manages the PAN) or the determined PAN (in the instance payment network 370 manages the PAN for the issuer) to issuer 360. The authorization request including the AcctID or the PAN may be communicated to the issuer with the assistance of an issuer communication processor 350 that interfaces with payment network 370 and a payment processor 355 that may be employed to process transactions for account issuer 360. Upon receipt of the authorization request including the AcctID, issuer 360 may determine the PAN associated therewith by referencing its repository of PANs. Having determined the PAN or received in the authorization request, issuer 360 may proceed to determine an authorization response in reply to the authorization request. Global clearing processing module 345 may be used in clearing functions performed by payment network 370.

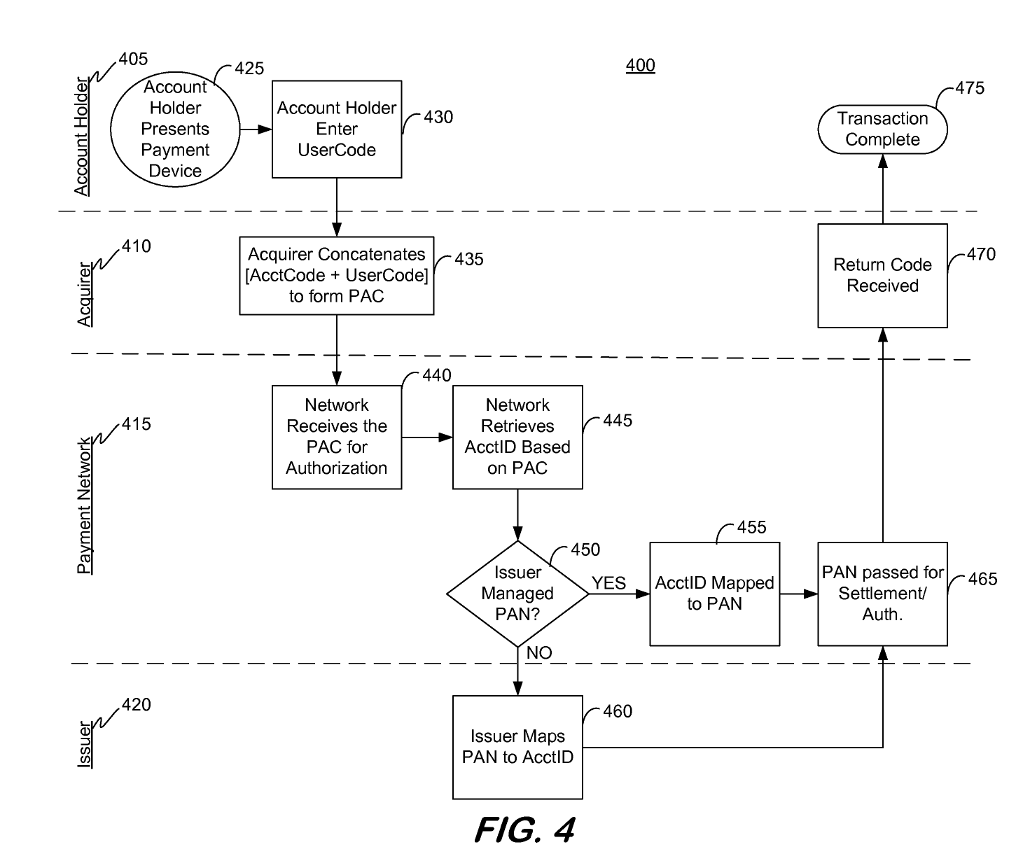

FIG. 4. is a flow diagram of a process 400 that illustrates the entities associated with some operations therein, in accordance with some embodiments herein. FIG. 4 shows a number of operations associated with an account holder 405 (i.e., user cardholder), an acquirer 410, a payment network 415, and an issuer 420. The operation performed by each of these entities will now be discussed in the context of a transaction involving a payment device issued with a AcctCode (not PAN), as disclosed in detail herein. Account holder 405 presents the payment device including the AcctCode to a merchant at a merchant's location such as a POS terminal, at operation 425. At operation 430, the account holder enters their UserCode associated with the AcctCode at the merchant location.

Acquirer 410 associates the AcctCode with the UserCode at operation 435 to form or otherwise determine the PAC. The associating of the AcctCode with the UserCode at operation 435 may include, but is not limited to, the acquirer concatenating the UserCode to the AcctCode.

Payment network 415 receives the PAC in the example of FIG. 4 for authorizing the current transaction using the determined PAC at operation 440. Based on the PAC, the payment network may retrieve or otherwise determine the corresponding AcctID at operation 445. Furthermore, payment network 415 may determine whether the issuer manages the PAN at operation 450. If the issuer manages the PAN, that is if the issuer alone stores and knows the PAN, then the AcctID is sent to issuer 420 where the issuer maps the PAN to the AcctID at operation 460. If the issuer does not manage the PAN but the payment network does (i.e., the issuer distributes the PAN to the payment network), then the payment network maps the AcctID to the PAN at operation 455. At operation 465, the PAN is passed for authorization and settlement.

An authorization response is received by the acquirer at operation 470 to complete the authorization of the transaction. When the settlement of the transaction concludes, the transaction is completed at operation 475.

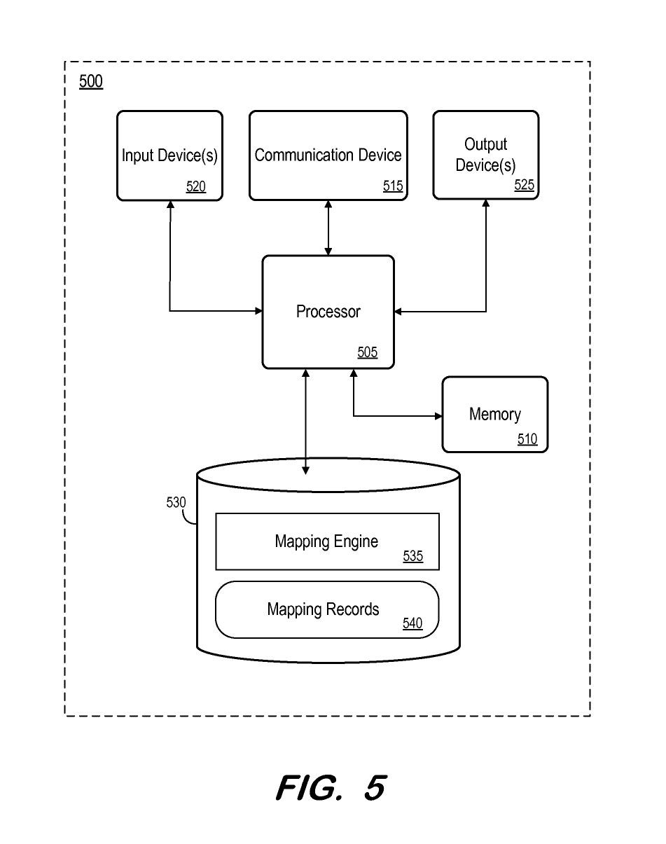

FIG. 5 is a block diagram overview of a system or apparatus 500 according to some embodiments. System 500 may be, for example, associated with any of the devices described herein, including for example a merchant system device; an acquirer device or server; an application or service server of a payment network operator supporting or providing, at least in part, UserCode assignments, a PAC-AcctID mapping and/or an AcctID-PAN mapping; and an account issuer device or system. System 500 comprises a processor 505, such as one or more commercially available Central Processing Units (CPUs) in the form of one-chip microprocessors or a multi-core processor, coupled to a communication device 515 configured to communicate via a communication network (not shown in FIG. 5) to another device or system. In the instance system 500 comprises a server (e.g., supporting the functions and services provided by a payment network operator), communication device 515 may provide a means for system 500 to interface with a client device (e.g., an acquirer system or device). System 500 may also include a local memory 510, such as RAM memory modules. The system further includes an input device 520 (e.g., a touchscreen, mouse and/or keyboard to enter content) and an output device 525 (e.g., a touchscreen, a computer monitor to display, a LCD display).

Processor 505 communicates with a storage device 530. Storage device 530 may comprise any appropriate information storage device, including combinations of magnetic storage devices (e.g., a hard disk drive), optical storage devices, and/or semiconductor memory devices. In some embodiments, storage device may comprise a database system such as a relational database management system and an in-memory database.

Storage device 530 stores program code 535 that may provide computer executable instructions for a mapping engine 535 for processing payment transactions including, in some aspects the PAC-AcctID mapping and/or the AcctID-PAN mapping aspects associated with receiving a PAC in an authorization request for a particular transaction, in accordance with some processes herein. Processor 505 may perform the instructions of the program code 535 to thereby operate in accordance with any of the embodiments described herein. Program code 535 may be stored in a compressed, uncompiled and/or encrypted format. Program code 535 may furthermore include other program elements, such as an operating system, a database management system, and/or device drivers used by the processor 505 to interface with, for example, peripheral devices. Storage device 530 may also include data 540 such as database records or look-up tables. Data 540 may be used by system 500, in some aspects, in performing the processes herein, including the PAC-AcctID mapping and/or an AcctID-PAN mapping.

All systems and processes discussed herein may be embodied in program code stored on one or more non-transitory computer-readable media. Such media may include, for example, a floppy disk, a CD-ROM, a DVD-ROM, magnetic tape, and solid state Random Access Memory (RAM) or Read Only Memory (ROM) storage units and other non-transitory media, where the tangible non-transitory media may back up a “cloud” storage facility. Moreover, in-memory technologies may be used such that databases, etc. may be completely operated in RAM memory at a processor. Embodiments are therefore not limited to any specific combination of hardware and software.

In some embodiments, a cardholder herein may only submit the AcctCode (e.g., 12 numeric digits) for online transactions. In some instances the merchant's e-commerce system may optionally store the user cardholder's AcctCode for future transactions. The merchant's e-commerce system may, at the time of a transaction, prompt the cardholder for their UserCode. In this manner, a full accounting of the AcctCode and the UserCode is not stored in a merchant's (or merchant acquirer's) repository.

In some embodiments, in the event a cardholder's payment device or asset including the AcctCode (e.g., credit card, key chain mini-card, etc) is stolen or lost, the cardholder may request a replacement payment device, as opposed to requiring the issuance of a new payment device. Herein, the cardholder need only change their user code (UserCode) rather than relying on a new card being issued with a new PAN and expiration date. This aspect of some embodiments herein may be beneficial in situations where, for example, a card may be pre-registered for monthly or annualized payments. It is also noted that the UserCode may electively be changed at any time, in real time, by the card holder in the event the cardholder knows or suspects their UserCode has been compromised (e.g., skimmed, etc.).

In some aspects herein, embodiments of a payment device may be embodied in an application, “app”, program, a browser (or browser-enabled application, extension, or add-on), computer-readable instructions and the like executing on a mobile device, and a device having a processor to execute an application or program instructions. In some aspects, such devices may be said to be encompassed by disclosures herein referring to a electronic device or “mobile device”, even where such an electronic device may not necessarily be easily transported (e.g., a desktop PC). In some aspects, the mobile device may be a device including telephony functionality and implemented as any number of different hardware, software, and combination thereof configurations.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method, the method comprising:
receiving an authorization request associated with a transaction, the authorization request including an account code;
receiving a user code to associate with the account code;
associating the account code and the user code together to form a payment account code;
determining an account identifier corresponding to the payment account code;
determining whether to map the payment account code to a primary account number (PAN);
mapping, in response to the determination that the payment account code is to be mapped to the PAN, the payment account code to the PAN to ascertain a PAN corresponding to the payment account code; and
sending the authorization request to be authorized, the authorization request including the PAN.

2. The method of claim 1, wherein the associating of the account code and the user code together to form the payment account code comprises concatenating the account code and the user code to each other.

3. The method of claim 1, wherein the associating of the account code and the user code together to form the payment account code comprises replacing at least a portion of the received account code with the user code

4. The method of claim 1, wherein the payment account code comprises a 16-digit numeric string.

5. The method of claim 1, wherein the user code is received as part of the authorization request and is distinct from the account code.

6. The method of claim 1, wherein the user code is received from a user.

7. The method of claim 1, wherein the determining of whether to map the payment account code to the PAN is based on, at least in part, whether a record of the PAN is maintained by a third party.

8. The method of claim 7, in an instance the PAN is maintained by a third party, further comprises:
determining not to map the payment account code to the PAN; and
sending an authorization request including the account identifier to be authorized, the PAN to be determined by the third party.

9. The method of claim 1, further comprising maintaining a record of a mapping between the account identifier and the payment account code.

10. An apparatus comprising:
a processor; and
a memory device in communication with the processor and storing program instructions thereon, the processor operative with the program instructions to:
receive an authorization request associated with a transaction, the authorization request including an account code;
receive a user code to associate with the account code;
associate the account code and the user code together to form a payment account code;
determine an account identifier corresponding to the payment account code;
determine whether to map the payment account code to a primary account number (PAN);
map, in response to the determination that the payment account code is to be mapped to the PAN, the payment account code to the PAN to ascertain a PAN corresponding to the payment account code; and
send the authorization request including the PAN to be authorized.

11. The system of claim 10, wherein the associating of the account code and the user code together to form the payment account code comprises concatenating the account code and the user code to each other.

12. The system of claim 10, wherein the associating of the account code and the user code together to form the payment account code comprises replacing at least a portion of the received account code with the user code

13. The system of claim 10, wherein the payment account code comprises a 16-digit numeric string.

14. The system of claim 10, wherein the user code is received as part of the authorization request and is distinct from the account code.

15. The system of claim 10, wherein a record of the PAN is not stored by the system.

16. The system of claim 10, wherein the determining of whether to map the payment account code to the PAN is based on, at least in part, whether a record of the PAN is maintained by a third party.

17. The system of claim 16, in an instance the PAN is maintained by a third party, further comprises:
determining not to map the payment account code to the PAN; and
sending an authorization request including the account identifier to be authorized, the PAN to be determined by the third party.

18. The system of claim 10, further comprising maintaining a record of a mapping between the account identifier and the payment account code.

19. The system of claim 10, wherein the user code is received from a user.
